(19) United States
(12) Patent Application Publication
(10) Pub. No.: US 2026/0266962 A1
(43) Pub. Date: Sep. 10, 2026

(54) RECONFIGURABLE SINGLE-PHOTON AVALANCHE DIODE SENSORS

(71) Applicant: OMNIVISION TECHNOLOGIES, INC., Santa Clara, CA (US)

(72) Inventor: Andreas Suess, San Jose, CA (US)

(21) Appl. No.: 19/071,636

(22) Filed: Mar. 5, 2025

(51) Int. Cl. G01S 7/481; G01B 11/22; G01S 7/4865; G01S 17/894

(52) U.S. Cl. CPC G01S 7/4816; G01B 11/22; G01S 7/4865; G01S 17/894

(57) ABSTRACT

Reconfigurable single-photon avalanche diode (SPAD) sensors (and associated systems, devices, and methods) are disclosed herein. In one embodiment, a reconfigurable SPAD sensor includes a plurality of SPADs configured to detect photon events corresponding to incident light from an external scene. A summation circuit is coupled to the SPADs and configured to generate sums of photon events detected by the SPADs using a synchronous summation technique (SST). An in-pixel static random-access memory (SRAM) is coupled to the summation circuit and configured to store photon event counts corresponding to at least one SPAD of the plurality. In some embodiments, the reconfigurable SPAD sensor further comprises a ripple counter circuit coupled to the SPADs. The SPAD sensor is reconfigurable to transition between operating in a depth mode to obtain distance information related to objects within the external scene and operating in an intensity mode to obtain intensity information corresponding to the incident light.

### TECHNICAL FIELD

This disclosure relates generally to image sensors. For example, several embodiments of the present technology described in detail below relate to image sensors (and associated systems, devices, and methods) that are reconfigurable to transition between operating in a depth mode and operating in an intensity mode, and that are configured to make time-of-flight (ToF) calculations.

### BACKGROUND

Image sensors have become ubiquitous and are now widely used in digital cameras, cellular phones, security cameras, as well as medical, automobile, and other applications. As image sensors are integrated into a broader range of electronic devices, it is desirable to enhance their functionality, performance metrics, and the like in as many ways as possible (e.g., resolution, power consumption, dynamic range, etc.) through both device architecture design as well as image acquisition processing.

Image sensors operate in response to image light coming from an external scene that is incident upon the image sensor. An image sensor includes an array of pixels having photosensitive elements (e.g., photosensors, photodiodes) that absorb a portion of the incident image light and, in response, generate corresponding electrical charge. The electrical charge of individual pixels may be measured as an output voltage of each photosensitive element. In general, the output voltage varies as a function of the intensity and duration of the incident light. The output voltage of individual photosensitive elements can be used to produce a digital image (e.g., image data) representing the external scene.

In some applications, photodiodes (e.g., single-photon avalanche diodes) may be used to perform time-of-flight (ToF) calculations. This may be accomplished, for example, by counting photodiode trigger events, storing the counts in corresponding bins of a histogram, and detecting and using a peak of the histogram to perform depth calculations.

### BRIEF DESCRIPTION OF THE DRAWINGS

Non-limiting and non-exhaustive embodiments of the present technology are described below with reference to the following figures, in which like or similar reference numbers are used to refer to like or similar components throughout unless otherwise specified.

FIG. 1 is a partially schematic diagram illustrating a time-of-flight (ToF) imaging system in an example environment, the ToF imaging system configured in accordance with various embodiments of the present technology.

FIG. 2A is a partially schematic, functional block diagram illustrating a reconfigurable single-photon avalanche diode (SPAD) sensor operating in a depth mode, the reconfigurable image sensor configured in accordance with various embodiments of the present technology.

FIG. 2B is a partially schematic, functional block diagram of the reconfigurable SPAD sensor of FIG. 2A operating in an intensity mode of operation in accordance with various embodiments of the present technology.

FIG. 3A is a partially schematic circuit diagram illustrating a pixel pulsing and reset circuit configured in accordance with various embodiments of the present technology.

FIG. 3B is a partially schematic circuit diagram illustrating a pulse shortener circuit configured in accordance with various embodiments of the present technology.

FIG. 4 is a partially schematic circuit diagram illustrating a synchronous summation technique (SST) engine circuit configured in accordance with various embodiments of the present technology.

FIG. 5 is a partially schematic circuit diagram illustrating a ripple counter circuit configured in accordance with various embodiments of the present technology.

FIG. 6 is a partially schematic circuit diagram illustrating a timestamping, adding, and memory circuit configured in accordance with various embodiments of the present technology.

FIG. 7 is a timing diagram illustrating a method of operating a reconfigurable SPAD sensor in a depth mode of operation in accordance with various embodiments of the present technology.

FIG. 8 is a timing diagram illustrating a method of operating a reconfigurable SPAD sensor in an intensity mode of operation in accordance with various embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

As described in greater detail below, the technology disclosed herein relates to reconfigurable SPAD sensors that can cycle between operating in a depth mode of operation and an intensity mode of operation. In depth mode, a reconfigurable SPAD sensor is usable to determine distance between the reconfigurable sensor and objects positioned within an external scene (e.g., calculated by measuring the time it takes for a laser pulse to travel to the objects and back). In intensity mode, a reconfigurable SPAD sensor is usable to measure strength of a reflected laser signal from objects within an external scene, indicating how much emitted light returned to the reconfigurable sensor (e.g., influenced by surface reflectivity of the objects and their angles relative to the laser pulses). The reconfigurable SPAD sensors of the present technology can switch between depth mode and intensity mode through use of reconfigurable circuitry and control signals. For example, reconfigurable SPAD sensors of the present technology can include multiplexers that can route signals differently depending on the selected mode, and/or ripple counters configured to operate differently depending on the selected mode. Thus, reconfigurable SPAD sensors of the present technology can utilize same hardware components for both depth and intensity measurements.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

Temporal relative terms such as “simultaneously,” “substantially simultaneously,” or “at the same time” are used herein to describe simultaneous performance or operation occurrence in a near instantaneous manner that takes into account necessary delays in signal transmission and/or processing, such as circuitry processing time, signal propagation time, computing time, or the like associated with circuit components. Thus, unless otherwise specified, “simultaneously,” “substantially simultaneously,” or “at the same time” as used herein may refer to events or operations that occur at the exact same time or within one second or less of each other after taking into account signal transmission and/or processing.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments. As another example, an element can be termed a “third element” to distinguish the element (e.g., for antecedent-basis purposes) from another element termed a “first element,” and without requiring the presence of a second element.

It is appreciated that the term “semiconductor material” recited throughout the disclosure may correspond to a part of or an entirety of a semiconductor wafer (e.g., a silicon wafer). In some embodiments, the semiconductor material may include or otherwise formed of silicon, a silicon germanium alloy, germanium, a silicon carbide alloy, an indium gallium arsenide alloy, any other alloys formed of III-V group compounds, combinations thereof, one or more epitaxial layers of the aforementioned materials, or a bulk substrate thereof. More specifically, semiconductor material may correspond to any semiconductor material or combination of materials that may be doped or otherwise configured to facilitate the formation of an integrated circuit (e.g., forming individual circuitry components such as source/drain regions of transistors, memory elements, photodiodes, or the like). It is appreciated that the term “photodiode” may correspond to a doped region disposed within the semiconductor material configured to photogenerate image charge(s) (e.g., one or more electrons or holes) in response to incident light. For example, photodiode may correspond to an n-doped region disposed within a p-type semiconductor material or an n-doped region surrounded by a p-type well disposed within the semiconductor material.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. Overview

As discussed above, photodiodes (e.g., single-photon avalanche diodes) may be used to perform time-of-flight (ToF) calculations, which can be useful for determining distances between (a) objects in an external scene and (b) the photodiodes or a corresponding image sensor. This may be accomplished, for example, by measuring the time it takes for laser pulses to travel to the objects and back. More specifically, photodiodes can be used to count photodiode trigger events over a period of time that is synced with (e.g., starts at) emission of a laser pulse, store the counts in bins of a histogram that correspond to segments of time within the period of time, detect a peak in the resulting histogram, and utilize the peak to perform depth calculations. In addition, photodiodes (e.g., single-photon avalanche diodes) may be used to perform intensity calculations, which can be useful for measuring strength of a reflected laser signal from objects within an external scene, indicating how much emitted light was reflected back to the reconfigurable sensor and/or providing information regarding surface reflectivity of the objects and/or their angles relative to the laser pulses.

Many such image sensors, however, are susceptible to photon pileups, which is a phenomenon that occurs when multiple photons (e.g., from a light source and/or an ambient environment) strike a photodiode at a same time or within a short period of time, causing the image sensor to only register a first photon strike and effectively “miss” subsequent photon strikes. Photon pileup can lead to distortion of histogram data (e.g., a true histogram signal peak being buried in the tail of the photon pileup), which can lead to inaccurate depth measurements using the image sensor especially in bright or high-light environments in which multiple photons are likely to strike a photodiode simultaneously or in a short period of time.

Thus, some image sensors employ various technologies to attempt to address or avoid photon pileups. For example, some image sensors employ time correlated single photon counters using an XOR logic tree to generate edges at every event from a group of SPADs. The XOR logic tree is then read out, and multi-bit time-to-digital converters (TDCs) are used to encode multiple events per laser pulse. Photon pileups are still observed in such image sensors, and the technology uses a large number of cascaded flip flops to store histogram data, which limits scalability.

As another example, some image sensors employ a synchronous summation technique (SST) in lieu of an XOR tree and/or multi-bit TDC. Although such image sensors can successfully avoid photon pileups using SST, all such image sensors known to the inventors (a) use complex hardware/memory to encode amplitude (e.g., number of SPADs firing within a time segment) and (b) use either off-chip memory or sensor-level memory to store counts/histogram data. As a result, scalability of such image sensors is limited (e.g., due to use of large memory circuits and/or large system buses), and use off-chip or sensor-level memory poses bottlenecks to interface speeds.

To address at least some of these concerns, the present technology is generally directed to reconfigurable SPAD sensors that can cycle between operating in a depth mode of operation (e.g., to determine distances to objects within an external scene) and an intensity mode of operation (e.g., to obtain signal strength information and/or information regarding object surface reflectivity and/or angle/orientation with respect to a system light source). The reconfigurable SPAD sensors can utilize a large number of the same hardware blocks in both modes of operation, thereby keeping the footprint of such sensors small in comparison to sensors that employ entirely different circuitry for the different operating modes. Furthermore, reconfigurable SPAD sensors of the present technology can utilize in-pixel static random-access memory (SRAM) as memory for storing histogram data, which is expected to improve both scalability of the SPAD sensors and interface speeds. Moreover, while operating in depth mode, reconfigurable SPAD sensors of the present technology can employ an SST block, thereby avoiding or lessening the risk of encountering photon pileups. In addition, in some embodiments, outputs of the SST block can be asynchronous, thereby obviating the practice of distributing high speed clock signals for memory control. Additionally, or alternatively, when operating in the intensity mode, reconfigurable SPAD sensors of the present technology can utilize ripple counters that employ ping-pong buffers to resolve timing problems associated with slower SRAM access times than photon detection times.

In some embodiments, reconfigurable SPAD sensors of the present technology can include an array of SPADS arranged in groups (e.g., of 4 SPADS arranged in a 2×2 array). Each group of SPADs can be coupled to a SPAD front-end circuit (SPAD FE), a summation circuit, a timer, a D flip-flop (DFF) circuit, a decoder, SRAM, one or more ripple counters, and/or a memory controller/full adder circuit. In depth mode, the reconfigurable SPAD sensors can count the number of photon events detected by (e.g., 2×2) groups of SPADS. For example, the timer for a group of SPADs can be reset at a time corresponding to when a laser pulse is emitted into an external scene by a light source of an associated imaging system. After the reset, the timer can begin counting while the SPADs of the group are used to detect incident photons. When a photon event is detected by one or more SPADs of the group, the corresponding SPAD FE can generate a pulse that is counted by the summation circuit using SST. In response to receiving the pulse from the SPAD FE, the SST can control the DFF circuit to latch the timer value (also referred to herein as a timecode) output by the timer to timestamp detection of the photon event. In turn, the decoder can translate the sampled timecode into an address of a row in the SRAM, which corresponds to a bin of a histogram constructed using detected photon events. More specifically, the SRAM can store a histogram of pulse counts, with each row in the SRAM corresponding to a bin of the histogram, and each bin corresponding to a segment of a period of time following emission of the laser pulse by the light source. A current pulse count for the bin addressed by the timecode can be read out the full adder, updated to reflect the detected photon event (e.g., by combining the current pulse count that is read out from the SRAM with the output of the summation circuit), and written back into the same row of the SRAM as an updated value. One or more of the SPADs of the group can be reset, such as after the updated pulse count is written into the histogram. Resetting the one or more SPADs can enable the SPAD(s) to detect new/additional photon events. Additional photon events detected by the SPADs can be counted and stored to the SRAM in a manner similar to that described above. The above process can be repeated for each laser pulse emitted into the external scene by the light source, with the ripple counter(s) used to track a number of laser pulses emitted by the light source.

Continuing with the above example, in intensity mode, the reconfigurable SPAD sensors can again utilize the SPADs to detect photon events, this time with the summation circuit disabled and the ripple counter(s) configured to track photon events on an individual SPAD basis. For example, the SPAD FE can, for each individual SPAD, generate a pulse for each detected photon event, which can be counted by a corresponding one of the ripple counters. As a specific example, the ripple counters can operate in a pipelined manner, with each SPAD potentially connected to its own ripple counter. The ripple counters can employ a ping-pong structure, enabling a first portion of the ripple counters to count photon events while a second portion of the ripple counters is used to output photon event counts to the full adder for storage in an appropriate row of the SRAM. Such an approach is expected to reduce the likelihood of photon pileups that may otherwise occur as a result of slower SRAM access times. As discussed in greater detail below, in intensity mode, the SRAM can be used to store photon event counts and overflow timer values for each SPAD. The overflow timer value for each SPAD can correspond to the time value output by the timer when a photon event count for the SPAD has been maxed out/saturated due to memory constraints of a row/bin in the SRAM. For each SPAD, the corresponding photon event count and the corresponding overflow timer value can be used to determine intensity values, as discussed in greater detail below.

### B. Selected Embodiments of Event Vision Sensors with Digital Event Detection, and Associated Systems. Devices, and Methods

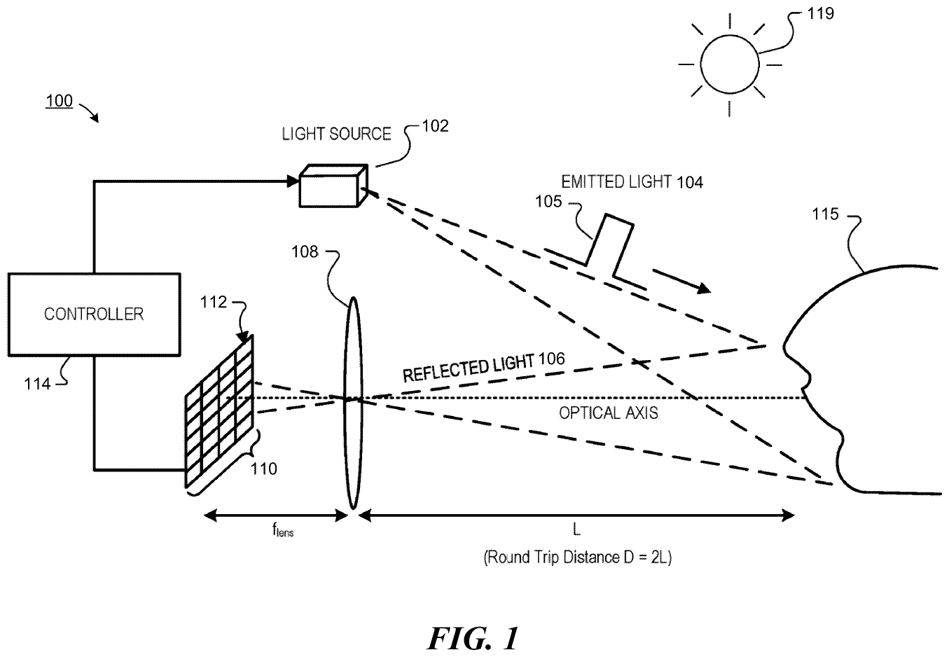

FIG. 1 is a partially schematic diagram illustrating a time-of-flight (ToF) imaging system 100 (“the system 100”) configured in accordance various embodiments of the present technology. As shown, the system 100 includes a light source 102, a lens 108, a pixel array 110 including a plurality of photomultiplier pixel cells 112, and a controller 114. The controller 114 is configured to control (e.g., synchronize) operation of the light source 102 and the plurality of photomultiplier pixel cells 112 included in pixel array 110. In addition, the controller 114 can be coupled to the pixel array 110 to receive and process information readout from the photomultiplier pixel cells 112.

In the illustrated embodiment, the pixel array 110 is positioned at a focal length fiens from the lens 108. In this example, the light source 102 and the lens 108 are positioned a distance L from an object 115. It is appreciated that FIG. 1 is not illustrated to scale and that, in at least one example, the local length fₗₑₙₛ is substantially less than the distance L between the lens 108 and the object 115. Therefore, it is appreciated that the distance L and the distance L+focal length fₗₑₙₛ can be substantially equal for the purposes of time-of-flight measurements obtained in accordance with the teachings of the present technology. As illustrated, the pixel array 110 and the controller 114 are represented as separate components for explanation purposes. It is appreciated, however, that the pixel array 110 and the controller 114 can be integrated into a same image sensor, such as a stacked chip sensor or a planar sensor.

Furthermore, it is appreciated that the pixel array 110 shown in FIG. 1 is illustrated as a two-dimensional (2D) array of photomultiplier pixel cells 112 arranged into a plurality of rows and a plurality of columns. As such, it is appreciated that the 2D pixel array 110 can be suitable for acquiring a three-dimensional (3D) image of the object 115 and/or other objects within an external scene. In another example, it is appreciated that the pixel array 110 can also be implemented as a one-dimensional array of photomultiplier pixel cells 112, which can be useful in line scan sensor applications (or the like), in accordance with various teachings of the present technology. Furthermore, in yet another example, it is appreciated that when the pixel array 110 is incorporated in light sensing systems that do not require time-of-flight measurements, the light source 102 can be omitted.

Referring again to the embodiment illustrated in FIG. 1, the system 100 can be configured as a 3D camera that calculates depth information related to distances between the system 100 and objects (e.g., the object 115) within an imaged external scene that are positioned within a field of view (FOV) of the system 100. The depth information can be based on time-of-flight measurements conducted using the light source 102, the pixel array 110, and the controller 114. The system 100 can operate in conditions with bright ambient light 119 (e.g., outside mid-day), and each photomultiplier pixel cell 112 in the pixel array 110 can determine depth information for a corresponding portion of the FOV such that a 3D image of objects (e.g., the object 115) in the external scene can be generated.

More specifically, depth information related to the object 115 can be determined by measuring a round-trip time (RTT) for light, emitted from the light source 102, to propagate from the light source 102 to the object 115 and back to the system 100. For example, referring to the illustrated embodiment, the light source 102 (e.g., a vertical-cavity surface-emitting laser) can be configured to emit light 104 (including light pulses 105) toward the object 115 over the distance L. At least some of the emitted light 104 can then be reflected off the object 115 as reflected light 106, some of which propagates towards the system 100 over the distance L, is focused onto the pixel array 110 by the lens 108, and is incident upon one or more photomultiplier pixel cells 112 of the pixel array 110 as image light. Each photomultiplier pixel cell 112 in the pixel array 110 can include one or more photon detectors (e.g., photosensors, photodiodes, etc., such as one or more SPADs) to detect the image light and convert the image light into an electrical output signal (e.g., image charge).

As shown in the depicted example, the round-trip time for light pulses 105 of the emitted light 104 can be used to determine the distance L (representing the distance between the object 115 and the lens 108/pixel array 110) using the following relationships in Equations (1) and (2) below in which c is the speed of light (e.g., approximately equal to 3×10⁸ m/s) and T_{TOF} is the round-trip time that represents an amount of time it takes for a light pulse 105 of light 104 emitted from the light source 102 to travel to and from an object in an external scene:

$${T}_{TOF} = \frac{2 L}{c} \qquad ( 1 )$$

$$L = \frac{{T}_{TOF} * c}{2} \qquad ( 2 )$$

Accordingly, once the round-trip time is determined using the system 100 and thereby becomes a known variable, the distance L can be calculated and subsequently used to determine depth information for the object 115 (e.g. how far away the object 115 is positioned from the system 100).

As discussed above and as shown in the illustrated embodiment, the controller 114 is configured to control the pixel array 110 (including the photomultiplier pixel cells 112) and the light source 102. In some embodiments, the controller 114 includes logic that, when executed, causes the system 100 to perform operations for determining the round-trip time, which can be based at least in part on timing signals generated and/or used by a time-to-digital converter. The timing signals can be representative of (a) when the light source 102 emits pulses 105 of emitted light 104 and (b) when the photomultiplier pixel cells 112 detect image light (e.g., as part of the reflected light 106). In these and other embodiments, the controller 114 can include various control circuitry for operating the system 100. As a specific example, the controller 114 can include row control circuitry that can be used to externally provide row addresses to reconfigurable SPAD sensors for accessing data stored to corresponding rows of in-pixel SRAMs (as described in greater detail below).

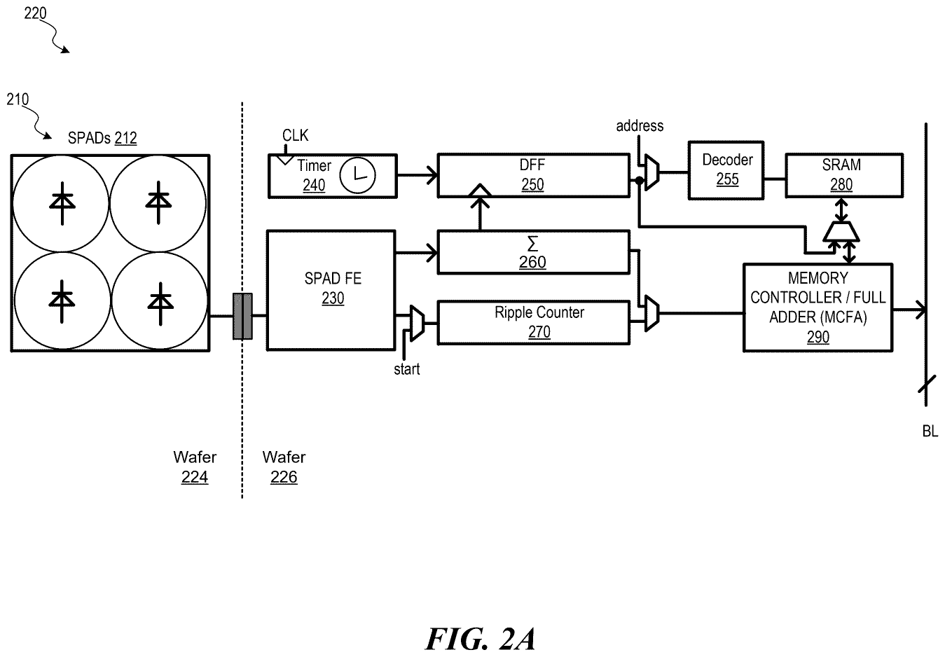

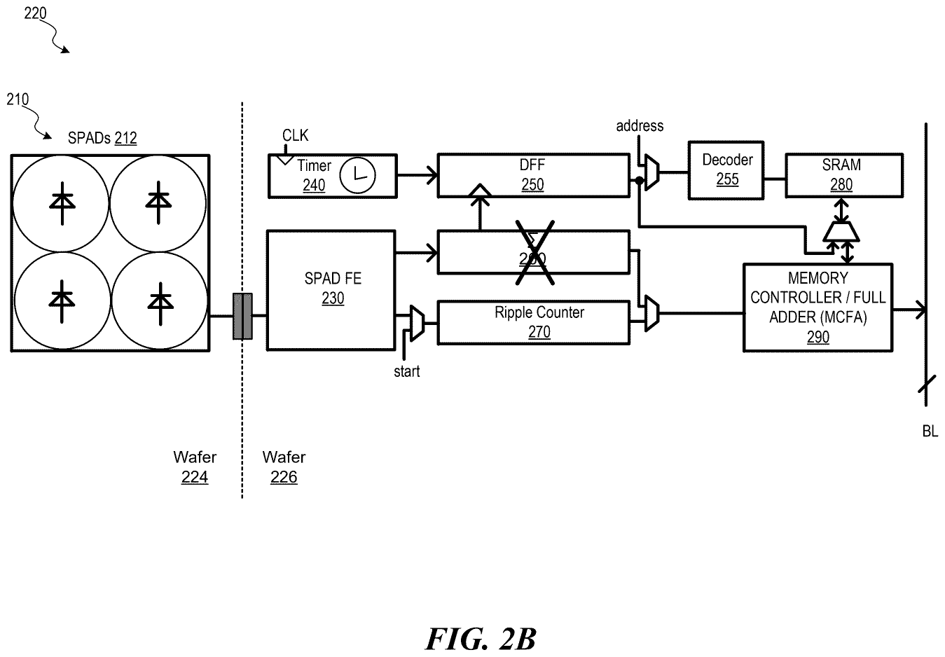

FIG. 2A is a partially schematic, functional block illustrating a reconfigurable single-photon avalanche diode (SPAD) sensor 220 (“the reconfigurable sensor 220”) operating in a depth mode and configured in accordance with various embodiments of the present technology. As discussed above, when operating in depth mode, the reconfigurable sensor 220 can be used to determine distances between (i) objects within an external scene and (ii) the reconfigurable sensor 220 (e.g., the distance L (or L+focal length fₗₑₙₛ) illustrated in FIG. 1 and described in detail above).

As shown, the reconfigurable sensor 220 includes an array 210 of photomultiplier pixel cells 212. The array 210 can be an example of all or a portion of the pixel array 110 of FIG. 1, or of other arrays configured in accordance with various embodiments of the present technology. In the illustrated example, the array 210 includes four photomultiplier pixel cells 212 positioned in a 2×2 arrangement. In other embodiments, the array 210 can include a different number of photomultiplier pixel cells 212 (e.g., one, two, three, or more than four photomultiplier pixel cells 212) and/or the photomultiplier pixel cells 212 of the array 210 can be positioned in a different arrangement (e.g., 1×4, 4×1, or another arrangement depending on the number of photomultiplier pixel cells 212 employed).

The photomultiplier pixel cells 212 each includes a photosensitive element (e.g., a photosensor), such as a photodiode. As discussed above, each photomultiplier pixel cell 212 is configured to photogenerate an electrical signal (e.g., image charge) in response to incident light from an external scene. In the illustrated embodiment (and in the embodiments described in greater detail below), the photomultiplier pixel cells 212 can each be a single-photon avalanche diode (SPAD) that is sensitive to single-photon strikes (e.g., a single photon incident on the photosensitive element of the photomultiplier pixel cell 212; also referred to herein as a photon event). The photomultiplier pixel cells 212 will therefore be referred to hereinafter as SPADs 212.

While operating in depth mode, the SPADs 212 of the array 210 can be treated as a single unit or group. For example, in depth mode, electrical signals generated by the four SPADs 212 of the array 210 can be combined/summed such that each photon event (e.g., a photon incident on a photosensitive element of a SPAD 212) detected by any one or more of the SPADs 212 is treated and counted as a photon event for the whole group. Stated another way, the group of four SPADs 212 shown in FIG. 2A can, for each latched timecode (described in greater detail below), be considered to have detected one photon event, two photon events, three photon events, or four photon events depending on a number SPADs 212 in the group that detected photon events during a period of time corresponding to that timecode. Although combining electrical signals generated by the SPADs 212 in this manner reduces spatial resolution by two in the horizontal direction and by two in the vertical direction, such combination of electrical signals is expected to (a) increase overall photon detection efficiency of the reconfigurable sensor 220, (b) increase signal-to-noise ratio of the reconfigurable sensor 220, and (c) decrease the likelihood of photon pileup.

As shown in FIG. 2A, the reconfigurable sensor 220 further includes a SPAD front-end (FE) 230, a timer 240, a D Flip-Flop (DFF) circuit 250, a summation circuit 260, a ripple counter circuit 270, a decoder 255, an SRAM 280, and a memory controller/full adder (MCFA) circuit 290. As illustrated, the SPADs 212 are disposed on a first wafer 224 that is bonded to a second wafer 226 on which the SPAD FE 230, the timer 240, the DFF circuit 250, the summation circuit 260, the ripple counter circuit 270, the decoder 255, the SRAM 280, the MCFA circuit 290, and various multiplexers and/or other logic circuitry are disposed. In some embodiments, the first wafer 224 can be bonded to the second wafer using a hybrid bond. In these and other embodiments, outputs of the SPADs 212 can be coupled to inputs of the SPAD FE 230 via interconnect structures (e.g., vias) and/or the hybrid bond.

Although a single instance of each of the components is shown in FIG. 2A, it is appreciated that an image sensor/imaging system can include more than one instance of one or more of the illustrated components. For example, an image sensor/imaging system can include multiple instances of the reconfigurable sensor 220 illustrated in FIG. 2A (e.g., multiple instances of the array 210 that together form a larger array of SPADs 212, with each instance of the array 210 including its own set of (e.g., dedicated) components positioned on the second wafer 226). In some of these embodiments, various circuit blocks can be shared amongst instances of the reconfigurable sensor 220. As a specific example, a single timer (e.g., a single instance of the timer 240) can be shared amongst multiple instances (e.g., two, three, four, or more instances) of the reconfigurable sensor 220, with each instance of the reconfigurable sensor 220 configured to latch timecodes output by the shared timer at times corresponding to when that instance detects a photon event. Handling of detected photon events and latching of timecodes is described in greater detail below. The reconfigurable sensor 220 illustrated in FIG. 2A is also referred to herein as a “pixel,” a “pixel unit,” and the like. Thus, in embodiments in which an image sensor/imaging system includes multiple instances of the reconfigurable sensor 220, the image sensor/imaging system can be described as including multiple pixels/pixel units/etc. Alternatively, each induvial SPAD 212 can be referred to herein as a “pixel,” a “pixel cell,” and the like.

In the illustrated embodiment, inputs of the SPAD FE 230 are coupled to outputs of the SPADs 212 of the array 210 and are configured to receive indications of photon events from the SPADs 212. More specifically, as discussed above, the SPADs 212 are each configured to detect photon events (e.g., individual photons incident on the SPAD 212). Incident photons can include photons from a light or laser pulse emitted by a light source (e.g., a light pulse 105 emitted from the light source 102 of FIG. 1; not shown in FIG. 2A) that reflects off of an object in an external scene and thereafter strike photosensitive elements of the SPADs 212. Additionally, or alternatively, incident photons can include photons from the ambient environment that strike photosensitive elements of the SPADs 212.

When a SPAD 212 detects a photon event, that SPAD 212 sends a signal to the SPAD FE 230 and becomes disabled from detecting further photon events until after it is reset/quenched and thereby re-enabled to detect a further photon event. As the SPAD FE 230 receives a signal from a SPAD 212 indicating that the SPAD 212 has detected a photon event, the SPAD FE 230 amplifies the signal into an event pulse that is output to and counted/summed by the summation circuit 260. More specifically, as shown, the SPAD FE 230 includes two outputs: a first output coupled to the summation circuit 260 and a second output coupled to the ripple counter circuit 270 via a multiplexer. In depth mode, the second output of the SPAD FE 230 is uncoupled from the ripple counter circuit 270 by the multiplexer, and when an enabled SPAD 212 of the group/array 210 of four SPADs 212 detects a photon event, the SPAD FE 230 can generate a corresponding event pulse that is provided, via the first output of the SPAD FE 230, to the summation circuit 260.

In turn, the summation circuit 260 (a) counts/sums (using a synchronous summation technique (SST)) event pulses received from the SPAD FE 230 to generate an event pulse count (also referred to herein as “sums,” “sums of event pulses,” “sums of photon events,” “sums of detected photon events,” and the like) for the group of SPADs 212, (b) uses one (e.g., a first) of the event pulses received from the SPAD FE 230 to clock the DFF circuit 250 to latch a timecode output by the timer 240 (as discussed in greater detail below), (c) uses one (e.g., the first) of the event pulses received from the SPAD FE 230 to generate a read/write pulse for accessing the SRAM 280 (as also discussed in greater detail below), and (d) outputs the event pulse count to the MCFA circuit 290 via a multiplexer that couples the output of the summation circuit 260 to the MCFA circuit 290 while the reconfigurable sensor 220 is in depth mode. As such, in the illustrated embodiment, event pulse counts maintained by the summation circuit 260 can range from zero to four and/or can depend on a number of SPADs 212 in the array 210 that detect photon events during a period of time associated with a latched timecode. Stated another way, although only one event pulse received by the summation circuit 260 within a given period of time can be used to latch a timecode, the summation circuit 260 can receive up to four event pulses from the SPAD FE 230 within the given period of time. Thus, for the illustrated embodiment, event pulse counts associated with each timecode can relate to up to four photon events detected by the SPADs 212 of the array 210 over the given period of time.

As discussed above, event pulses generated by the SPAD FE 230 while the reconfigurable sensor 220 is in depth mode are not provided to the ripple counter circuit 270 via the second output of the SPAD FE 230. Rather, while the reconfigurable sensor 212 operates in depth mode, the multiplexer prevents the ripple counter circuit 270 from receiving event pulses output by the SPAD FE 230, and instead passes the ripple counter circuit 270 a signal start that is used to indicate each time a new light pulse (e.g., each light pulse 105 of FIG. 1; not shown in FIG. 2A) is emitted by a light source (e.g., light source 102 of FIG. 1; not shown in FIG. 2A) corresponding to the reconfigurable sensor 220. In turn, the ripple counter circuit 270 can use the signal start (e.g., each assertion, each rising edge, and/or each falling edge of the signal start) to track/count a total number of light pulses emitted by the light source, which can correspond to an amount of histogramming windows recorded by the reconfigurable sensor 220. As discussed in greater detail below, the count of the total number of light pulses maintained by the ripple counter circuit 270 can be used to support intensity estimations in case of saturation of one or more histogram bins in the SRAM 280.

Referring now to the timer 240, the timer 240 is controlled by a clock signal CLK and is reset for each new light pulse emitted by a light source corresponding to the reconfigurable sensor 220. After being reset, the timer 240 begins counting according to the clock signal CLK and outputs timecode values to the DFF circuit 250. When the SPAD FE 230 generates an event pulse in response to at least one of the SPADs 212 of the array 210 detecting a photon event, a timecode value output by the timer 240 to the DFF circuit 250 is sampled by the DFF circuit 250 to timestamp detection of the photon event. More specifically, the SPAD FE 230 generates an event pulse that is output to the summation circuit 260. In turn, the summation circuit 260 counts the event pulse using SST and uses the event pulse to (a) clock the DFF circuit 250 to latch a current timecode value output from the timer 240 and (b) generate an SRAM read/write signal. Subsequent event pulses received by the summation circuit 260 from the SPAD FE 230 during a period of time associated with the latched timecode can be used to update the event count pulse using SST. As discussed above, the summation circuit 260 also outputs the event pulse count to the MCFA circuit 290.

After latching the timecode, the DFF circuit 250 outputs the latched timecode to the decoder 255 via a multiplexer, and the decoder 255 translates the sampled timecode into an address of a row in the SRAM 280. In some embodiments, the SRAM 280 includes 32 rows, with each row corresponding to 1 bin of a histogram that is constructed by the reconfigurable sensor 220 for each light pulse emitted by a light source corresponding to the reconfigurable sensor 220. Accordingly, the timecode values output by the timer 240 can be 5-bit values, providing 32 (e.g., 25) possible address values-one for each row of the SRAM 280. Of course, use of (a) SRAM with a greater or lesser number of rows and/or (b) timers configured to output timecode values having a greater or lesser number of bits, is possible and within the scope of the present technology.

The address obtained by the decoder 255 from the sampled timecode is used to access the corresponding row in the SRAM 280 and retrieve a current pulse count stored to that row. More specifically, as discussed above, the summation circuit 260 can use an event pulse received from the SPAD FE 230 to generate a read/write pulse. Thus, when the read/write pulse generated by the summation circuit 260 is high, the row in the SRAM 280 corresponding to the address obtained from the latched timecode can be accessed to (a) read out a current event pulse count stored to that row of the SRAM 280 and (b) provide the current event pulse count to the MCFA circuit 290 via a two-way multiplexer (shown positioned between the SRAM 280 and the MCFA circuit 290 in FIG. 2A). In turn, the MCFA circuit 290 can update the current event pulse count using the event pulse count received from the summation circuit 260. In some embodiments, the MCFA circuit can update the current event pulse count read out from the SRAM 280 with the event pulse count received from the summation circuit 260 by adding the event pulse count from the summation circuit 260 to the current event pulse count, such as using a full adder circuit. Thereafter, when the read/write pulse generated by the summation circuit 260 is low, the updated event pulse count computed by the MCFA circuit 290 can be written back to the corresponding row in the SRAM 280 via the two-way multiplexer.

Once the updated event count is written back into of the row of the SRAM 280 corresponding to the latched timecode, a reset pulse can be generated to reset one or more of the SPADs 212 of the array 210 and re-enable them to detect further photon events. In some embodiments, the reset pulse can be generated based at least in part on the read/write pulse, such as after a delay implemented by hardware and/or software of the reconfigurable sensor 220 based on the read/write pulse. Reconfigurable sensors 220 configured in accordance with various embodiments of the present technology can support various reset modes for the SPADs 212. In a first example reset mode, only SPADs 212 that detected photon events (a) that correspond to event pulses transmitted from the SPAD FE 230 to the summation circuit 260 during a given period of time associated with the latched timecode and (b) that were counted in the event pulse count that was used by the MCFA circuit 290 to update a current event pulse count stored in the SRAM 280, are reset. In this reset mode, any additional photon events detected by SPADs 212 of the array 210 during the SRAM read/write period and therefore not associated with the latched timecode and/or were not counted in the event pulse count, would be used by the summation circuit 260 to cause the DFF circuit 250 to latch a new timecode and be added to the histogram in the SRAM 280 as part of another event pulse count maintained by the summation circuit 260. In a second example reset mode, all of the SPADs 212 of the array 210 can be reset in response to the reset pulse. This second example reset mode is expected to avoid any wrong timestamping of detected photon events.

Confidence in a depth measurement derived from a histogram constructed by the reconfigurable sensor 220 can be directly related to the intensity of the detected signal. More specifically, a higher intensity generally leads to a more pronounced peak in the histogram, and thus to a more reliable depth measurement associated with a higher confidence. Intensity can be defined as a number of detected photon events over time, which is a measurement that can be obtained using event pulse counts stored to the SRAM 280.

More specifically, a light source (not shown) corresponding to the reconfigurable sensor 220 can be configured to emit a given number of light pulses (e.g., 200,000 light pulses) over an exposure period. In depth mode, the reconfigurable sensor 220 can be used to construct a histogram for the exposure period by counting photon events that are detected following emission of each of the light pulses during the exposure period. Thus, a histogram constructed by the reconfigurable sensor 220 can correspond to a plurality of light pulses emitted during the exposure period, with the reconfigurable sensor 220 configured to update bin values of the histogram over multiple windows, each window corresponding to a unique one of the light pulses emitted during the exposure period. To this end, the timer 240 can be reset each time a new light pulse is emitted such that the time at which the timer 240 is reset and begins counting is synchronized with the emission of each new light pulse, thereby enabling the reconfigurable sensor 220 to identify and update photon event counts of appropriate bins of the histogram per the discussion of the present technology above.

As discussed above, the histogram is stored to the SRAM 280, with each row in the SRAM 280 corresponding to a bin of the histogram. In some embodiments, each row of the SRAM 280 can be configured to store a finite number of bits (e.g., 14 bits), meaning that each row can track a finite number of total photon events (e.g., 16,383 photon events) for a given exposure period. Thus, in the event that the reconfigurable sensor 220 detects greater than the finite number of photon events for a given row of the SRAM 280, continued logging of detected photon events for other rows of the histogram would distort the histogram data. For this reason, when a row of the histogram stored to the SRAM 280 becomes saturated during a given exposure period, the reconfigurable sensor 220 can be configured to halt further accumulation of photon events in all rows of the SRAM 280, thereby enabling determination of absolute signal intensity (and therefore confidence) from photon event counts stored in the SRAM 280.

In particular, in the event that no bins of the SRAM 280 become saturated during a given exposure period, then absolute intensity associated with a corresponding histogram constructed by the reconfigurable sensor 220 can be determined at the end of the exposure period according to Equation (3) below:

$$intensity = \frac{number of photon events accumulated in SRAM}{total exposure time} \qquad ( 3 )$$

On the other hand, in the event that a bin of the SRAM 280 becomes saturated during a given exposure period, then accumulation of detected photon events can be frozen for all rows of the SRAM 280, and absolute intensity associated with a corresponding histogram constructed by the reconfigurable sensor 220 can be determined according to Equation (4) below in which time to saturation is equivalent to a duration of time between a start of the exposure period and a time the reconfigurable sensor 220 detects saturation of one of the rows of the SRAM 280:

$$intensity = \frac{number of photon events accumulated in SRAM}{time to saturation} \qquad ( 4 )$$

The time to saturation variable in Equation (4) above can be determined using the count of the total number of light pulses maintained by the ripple counter circuit 270 for the exposure period. More specifically, for each exposure period, the ripple counter circuit 270 can be configured to increment (e.g., using the signal start in FIG. 2A) a total light pulse count each time a new light pulse is emitted during the exposure period. When the reconfigurable sensor 220 detects saturation of a row of the SRAM 280 (e.g., by comparing a photon event count stored to a row of the SRAM 280 to a saturation threshold corresponding to a maximum photon event count storable in the row), the reconfigurable sensor 220 can assert a memory overflow flag that is used to (a) disable further accumulation of photon events in the SRAM 280 (e.g., by disabling all or a portion of one or more of the DFF circuit 250, the summation circuit 260, the MCFA circuit 290 (e.g., a full adder of the MCFA circuit 290), and/or the decoder 255) and (b) disable further incrementing of the total light pulse count maintained by the ripple counter circuit 270. The frozen value of the total light pulse count stored in the ripple counter circuit 270 can be used to determine the time to saturation variable in Equation (4) above, which can be used in combination with the frozen photon event counts in the SRAM 280 to determine absolute intensity per Equation (4) above. As shown in FIG. 2A, the multiplexer positioned between the DFF circuit 250 and the decoder 255 includes an input that is configured to receive an address signal address. The address signal address can be used at the end of an exposure period to read out histogram data from the SRAM 280 into the MCFA circuit 290 for output out of the reconfigurable sensor 220 via a bitline BL coupled to the MCFA circuit 290.

FIG. 2B is a partially schematic, functional block diagram illustrating the reconfigurable sensor 220 of FIG. 2A operating in an intensity mode in accordance with various embodiments of the present technology. As discussed above, when operated in intensity mode, the reconfigurable sensor 220 can be used to measure strength of reflected signals from objects within an external scene, indicating how much emitted light returned to the reconfigurable sensor (e.g., influenced by surface reflectivity of the objects and their angles relative to the laser pulses).

In intensity mode, the reconfigurable sensor 220 can utilize the SPADs 212 of the array 210 to detect photon events in a manner generally similar to how the SPADs 212 are used to detect photon events in depth mode. In contrast to depth mode, however, each SPAD 212 is treated individually as opposed to as a group. Thus, the reconfigurable sensor 220 is configured to accumulate photon events detected by each of the SPADs 212 and store a photon event count for each individual SPAD 212. To this end, in intensity mode, each SPAD 212 can be allocated two or more rows of the SRAM 280: one or more first rows that can be used to store a photon event count for a respective SPAD 212 and one or more second rows that can be used to store a timecode that is usable for absolute intensity calculations when the one or more first rows becomes saturated during an exposure period (as described in greater detail below).

Furthermore, in intensity mode, the summation circuit 260 can be disabled (as shown in FIG. 2B), and the second output of the SPAD FE 230 can be coupled to the ripple counter circuit 270 such that the ripple counter circuit 270 receives event pulses output by the SPAD FE 230. As discussed in greater detail below, for intensity mode, the ripple counter circuit 270 can internally be reconfigured to count photon event counts using event pulses received from the SPAD FE 230. (For depth mode, the ripple counter circuit 270 can be internally reconfigured to count light pulses emitted by a light source (not shown), such as using the signal start, as discussed in detail above with reference to FIG. 2A.)

In some embodiments, the ripple counter circuit 270 can include a plurality of ripple counters. As a specific example, the reconfigurable sensor 220 can include a ripple counter per SPAD 212 (e.g., four ripple counters in the illustrated embodiment, each SPAD 212 having its own dedicated ripple counter). As discussed in greater detail below, the ripple counter circuit 270 can employ ping-ping buffers that enable a first portion of each ripple counter to accumulate photon events detected by the corresponding SPAD 212 in a first photon event count while a second portion of each ripple counter outputs a second photon event count to the MCFA circuit 290. After a preset duration of time elapses, the second portion of each ripple counter can be used to accumulate photon events detected by the corresponding SPAD 212 in a third event count while the first portion of each ripple counter outputs its first photon event count to the MCFA circuit 290 for storage in the SRAM 280. Stated another way, each ripple counter of the ripple counter circuit 270 can include two circuits that operate in parallel. For example, a first circuit of the ripple counter can count event pulses output by the SPAD FE 230 to generate a first counter value that can be used to update a photon event count for a corresponding SPAD, while a second counter value generated and maintained by a second circuit is read out and summed with the corresponding data read out from the SRAM 280 to produce an updated photon event count that is written back to the SRAM 280. The ping-pong structure of each ripple counter is expected to reduce the likelihood of photon pileup as one of the parallel circuits can be used to update photon event counts stored to the SRAM 280 while the other of the parallel circuits continues to count additional photon events detected by the corresponding SPAD 212.

As shown in FIG. 2B, the MCFA circuit 290 is configured to receive, via the multiplexer positioned between the ripple counter circuit 270 and the MCFA circuit 290, photon event counts output from first and second portions of ripple counters of the ripple counter circuit 270. In addition, current photon event counts stored to the SRAM 280 can be read into the MCFA circuit 290 via the bidirectional multiplexer using addresses and associated read/write pulses provided by row control circuitry (not shown) of a corresponding image sensor/imaging system. For example, row control circuitry can provide an address of a row of the SRAM 280 to the decoder 255 via the multiplexer positioned between the DFF circuit 250 and the decoder 255 in FIG. 2B. The address can be used to access a corresponding row of the SRAM 280 to read out a current photon event count in accordance with a read/write pulse provided by the row control circuitry to, for example, the MCFA circuit 290. In turn, the MCFA circuit 290 (e.g., using a full adder circuit) can update the current photon event count read out from the SRAM 280 with a corresponding photon event count received from the first portion or the second portion of a corresponding ripple counter of the ripple counter circuit 270. After computing the updated photon event count, the updated photon event count can be written to the corresponding row of the SRAM 280, and a corresponding timecode value output by the timer 240 and the DFF circuit 250 to the bi-directional multiplexer can be stored to another row of the SRAM 280 associated with a same SPAD 212. The above process can be repeated for a next address and/or read/write pulse provided by the row control circuitry, at least until one of the rows of the SRAM 280 saturates.

Operation of the reconfigurable sensor 220 during intensity mode will now be described with reference to one of the SPAD 212 of the array 210 (referred to hereinafter as the first SPAD 212). It is appreciated that the reconfigurable sensor 220 can operate in a similar fashion for each of the other SPAD 212 of the array 210.

At or before a start of an exposure period, the timer 240 can be reset and begin counting from the beginning of the exposure period in accordance with a clock signal CLK. For intensity mode, the clock signal CLK can be slowed in comparison to the clock signal CLK used in depth mode so that the time it takes for the timer 240 to count through its full set of timecodes can span the full duration of the exposure period. Throughout the exposure period, timecodes generated by the timer 240 can be passed to the DFF circuit 250 and output to the bidirectional multiplexer. In some embodiments, the timer 240 and/or the DFF circuit 250 can be configured as a phase time-count generator (e.g., a 32-phase time-count generator) while the reconfigurable sensor 220 is in intensity mode. The timecodes generated by the timer 240 can be shared amongst the SPADs 212 of the array 210.

During the exposure period, each of the SPADs 212 of the array 210 are used to detect photon events. For example, as the first SPAD 212 detects a photon event, the first SPAD 212 outputs a corresponding electrical signal to the SPAD FE 230, which generates an event pulse that can be output to—and counted by—a first portion of a first ripple counter of the ripple counter circuit 270 that corresponds to the first SPAD 212. In some embodiments, the first SPAD 212 is reset immediately after (or shortly after) the SPAD FE 230 outputs the event pulse corresponding to the photon event detected by the first SPAD 212. Stated another way, in contrast with depth mode, the first SPAD 212 in intensity mode can be reset before the photon event detected by the first SPAD 212 is written to the SRAM 280, thereby quickly re-enabling the first SPAD 212 to detect further photon events and reducing the likelihood of photon pileup. This reset technique is referred to herein as immediate active recharge, immediate active reset, immediate active restart, and the like. The above process can be repeated for a next photon event detected by the first SPAD 212. A similar process can be employed for each of the other SPADs 212 of the array 210 using respective ripple counters of the ripple counter circuit 270.

After a preset duration has elapsed, control signals input into the ping-pong structure of the ripple counters of the ripple counter circuit 270 can switch which portions of the ripple counters are used to count/accumulate photon events and which portions are used to write photon event counts to the SRAM 280. Continuing with the example from above, the first portion of the first ripple counter can initially be used to count/accumulate photon events detected by the first SPAD 212. After the preset duration has elapsed, a second portion of the first ripple counter can be used to count/accumulate photon events detected by the first SPAD 212 while the first portion of the first ripple counter outputs its photon event count to the MCFA circuit 290. In addition, an address provided by row control circuitry (not shown) can be used to access/read out a current photon event count corresponding to the first SPAD 212 from a corresponding row of the SRAM 280 in accordance with a read/write pulse provided by the row control circuitry. In this manner, the row control circuitry can use addresses and/or read/write pulses provided to the reconfigurable sensor 220 to control/coordinate timings of when each photon event count stored in the SRAM 280 is read out, updated, and/or written back to the SRAM 280.

After a current photon event count for the first SPAD 212 has been read out from the SRAM 280, the MCFA circuit 290 can update the current photon event count with the photon event count received from the first portion of the first ripple counter corresponding to the first SPAD 212, and can write the updated photon event count back to the corresponding row of the SRAM 280. In addition, a current timecode output by the timer 240 and/or the DFF circuit 250 to the bidirectional multiplexer can be stored to another row of the SRAM 280 that is allocated to the first SPAD 212 for storing timecodes. Then, after a preset duration has elapsed, the first portion of the first ripple counter can again be used accumulate photon events detected by the first SPAD 212 while a second portion of the ripple counter outputs a photon event count to the MCFA circuit 290 to further update the corresponding photon event count stored in the SRAM 280 for the first SPAD 212.

Absent saturation during the exposure period of the row in the SRAM 280 allocated to storing the photon event count for the first SPAD 212, the photon event count stored to row of the SRAM 280 can, using an external address provided to the multiplexer shown positioned between the DFF circuit 250 and the decoder 255 in FIG. 2B, be read out from the SRAM 280 at the end of the exposure period and be output onto the bitline BL via the MCFA circuit 290. In this case, because no saturation occurred during the exposure period, an intensity value for the first SPAD 212 can be determined using Equation (3) above.

On the other hand, if the row of the SRAM 280 allocated to storing the photon event count for the first SPAD 212 becomes saturated during the exposure period (e.g., as determined by a comparison of the photon event count stored to the SRAM 280 to a saturation threshold), the reconfigurable sensor 220 can be configured to halt further accumulation of photon events in the row of the SRAM 280 allocated to the first SPAD 212 and can freeze further updating the timecode stored to another row of the SRAM 280 allocated to the first SPAD 212 for storing timecodes. In other words, when a row of the SRAM 280 storing a photon event count for the first SPAD 212 becomes saturated, timecodes output from the timer 240 during a remainder of the exposure period are not stored to the SRAM 280 in a row that corresponds to the first SPAD 212. In turn, the frozen timecode stored in the SRAM 280 for the first SPAD 212 can be used to determine the time to saturation variable of Equation (4) above, which can then be used to compute an intensity value for the SPAD 212. Unlike depth mode, rows in the SRAM 280 allocated to the other SPADs 212 in the array 210 can be treated independently in intensity mode from the saturated row(s) in the SRAM 280 corresponding to the first SPAD 212. Thus, although accumulation of photon events and updates to the timecode stored in the SRAM 280 for the first SPAD 212 are frozen when the corresponding row(s) become saturated, the reconfigurable sensor 220 can continue to accumulate photon events and update timecodes stored to the SRAM 280 for one or more of the other SPADs 212 of the array 210 so long as corresponding rows for those other SPADs 212 are not saturated.

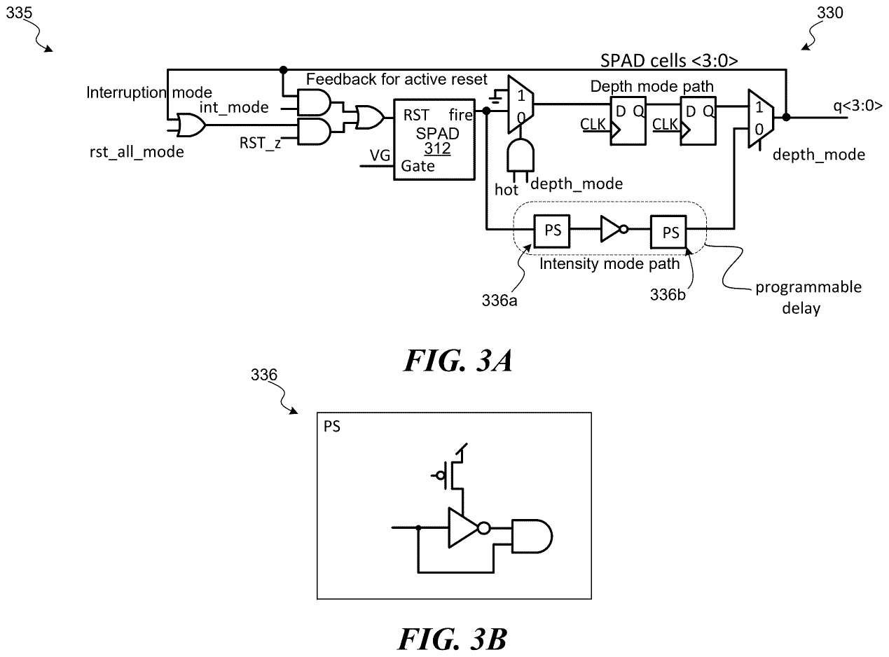

FIG. 3A is a partially schematic circuit diagram illustrating a pixel pulsing and reset circuit 335 (“the circuit 335”) of a reconfigurable sensor (e.g., the reconfigurable sensor 220 of FIGS. 2A and 2B) configured in accordance with various embodiments of the present technology. As shown, the circuit 335 includes a SPAD 312 and a SPAD FE 330. The SPAD 312 and/or the SPAD FE 330 can be an example of one of the SPADs 212 and/or of the SPAD FE 230 of FIGS. 2A and 2B, respectively, or of other SPADs and/or SPAD FEs configured in accordance with various embodiments of the present technology.

In accordance with the discussion above, the SPAD FE 330 can be configured to produce an event pulse q upon reception of an electrical signal (fire) from the SPAD 312 indicating detection of a photon event. As shown, the SPAD FE 330 of the circuit 335 includes two circuit paths: a depth mode path and an intensity mode path. While operating in depth mode, the output of the AND logic gate shown configured to receive a signal hot is initially low. As such, an electrical signal from the SPAD 312 can be passed through the multiplexer and latched twice along the illustrated depth mode path in accordance with the clock signal CLK to mitigate metasability before being output from the SPAD FE 330 as an event pulse q to a coupled summation circuit. As discussed in greater detail below, when the coupled summation circuit receives an event pulse q from the SPAD FE 330 of the circuit 335, the summation circuit can assert (e.g., after a delay) the signal hot, which can remain high until assertion of a reset signal RST_z. In turn, the output of the AND logic gate can be asserted, thereby preventing further event pulses q from being output to the coupled summation circuit from the SPAD FE 330 until the SPAD 312 and a latch holding the signal hot high are reset using the reset signal RST_z. This can ensure that a photon event count maintained by the coupled summation circuit and corresponding to a sampled timecode remains unchanged until it is written to a row of a coupled SRAM.

FIG. 3A also illustrates reset circuitry for the SPAD 312 and the SPAD FE 330. As shown, two reset mechanisms are supported for depth mode. If a signal rst_all_mode is asserted, all SPADs of a group including the SPAD 312 can be reset, including SPADs that were not sampled by the summation circuit for histogramming (yet may or may not have detected a photon event). On the other hand, if the signal rst_all_mode is not asserted, only SPADs of the group that caused the SPAD FE 330 to generate an event pulse q signal before the signal hot was asserted by the summation circuit will be reset. Subsequentially, other SPADs that output an electrical signal fire after the signal hot was asserted by the summation circuit pulse now will cause the SPAD FE 330 to generate an event pulse q that is output to the summation circuit and therafter summed, time-stamped, and histogrammed. In some embodiments, the SPAD 312 can quench passively or actively.

While operating in intensity mode, the summation circuit is disabled such that the signal hot is not asserted. Electrical signals fire output by the SPAD 312 propagate along the intensity mode path of the SPAD FE 330 and are output to a coupled ripple counter as event pulses q. Such event pulses q can be fed back to the SPAD 312 to provide immediate active reset after a programmable delay. The programmable delay is shown in FIG. 3A as being provided by a first pulse shortener circuit 336a, an inverter, and a second pulse shortener circuit 336b. An example implementation of a pulse shortener circuit 336 configured in accordance with various embodiments of the present technology is shown in FIG. 3B. Immediate active reset of the SPAD 312 when operating in intensity mode is expected to mitigate photon pileups.

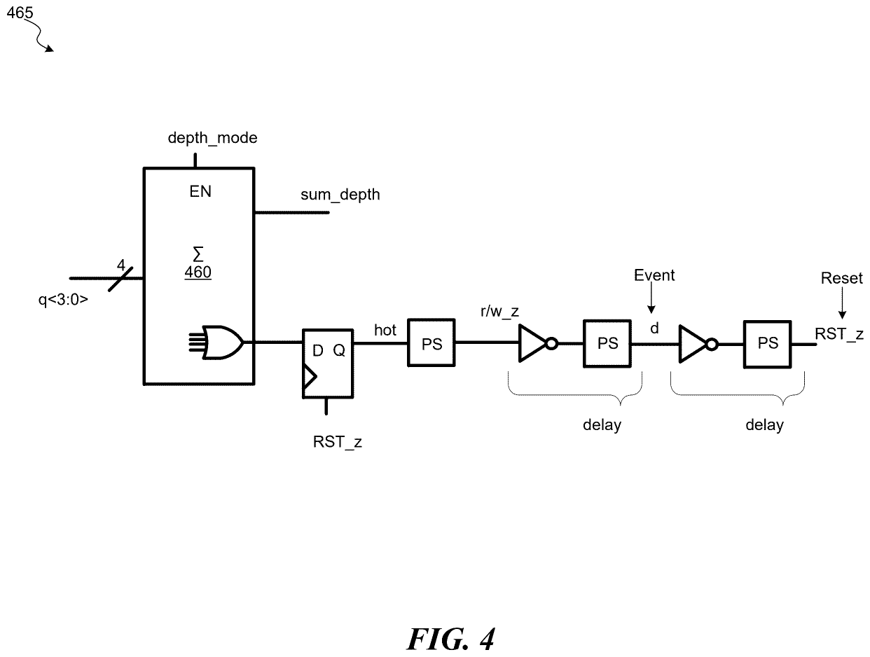

FIG. 4 is a partially schematic circuit diagram illustrating a synchronous summation technique (SST) engine circuit 465 (“the SST engine 465”) configured in accordance with various embodiments of the present technology. As shown, the SST engine 465 includes a summation circuit 460 and various other circuitry coupled to the summation circuit 460. The summation circuit 460 can be an example of the summation circuit 260 of FIGS. 2A and 2B, or of other summation circuits configured in accordance with various embodiments of the present technology.

As shown, the summation circuit 460 is enabled when in depth mode. When enabled, the summation circuit 460 is configured to receive event pulses q<3:0> from a coupled SPAD FE, each event pulse q corresponding to a SPAD coupled to the SPAD FE. A sum sum_depth of the asserted event pulses q<3:0> is computed, timestamped, output to a coupled MCFA, and histogrammed. In addition, when any one or more of the event pulses q<3:0> are asserted (indicating that one or more of the coupled SPADs have detected a photon event), an output of an OR logic gate is asserted, which is latched. In turn, the signal hot output from the latch is asserted and remains high until the latch is reset using the reset signal RST_z. As discussed above, the asserted signal hot is used to latch the event pulses q<3:0> and prevent changes of the sum sum_depth while writing the sum sum_depth into a coupled SRAM.

As shown in FIG. 4, the asserted signal hot is fed into a pulse shortener circuit, the output of which is a read/write pulse r/w_z that is used by a coupled SRAM to indicate a reading interval. The read/write pulse r/w_z is then fed into an inverter and into a second pulse shortener circuit. The inverter and the second pulse shortener circuit implement a delay during which updated photon event counts at a coupled MCFA are written back into the coupled SRAM. The output of the second pulse shortener circuit is fed into a second inverter and then into a third pulse shortener circuit, which are used to implement another delay and thereafter assert the reset signal RST_z. As discussed above, the RST_z is used to reset the latch of the SST engine 465 and to actively quench SPADs coupled to the SST engine 465.

Use of asynchronous time-elements in the SST engine 465 for generating asynchronous read/write pulses r/w_z, asynchronous write pulses d, and asynchronous reset signals RST_z are expected to obviate distributing a high-speed clock signal to various circuits of a corresponding reconfigurable sensor for controlling SRAM access and SPAD reset times. For example, although counter-based delays may be implemented and utilized to generate read/write pulses r/w_z, write pulses d, and reset signals RST_z, large flip-flops counts may be required that would need to be driven by a plurality of different clock signals.

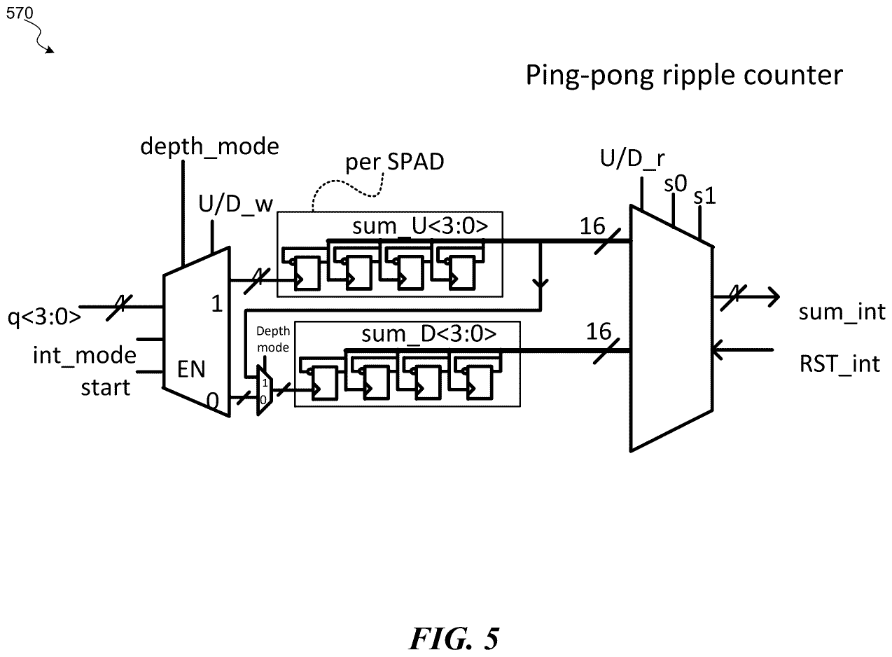

FIG. 5 is a partially schematic circuit diagram illustrating a ripple counter circuit 570 configured in accordance with various embodiments of the present technology. The ripple counter circuit 570 can be an example of the ripple counter circuit 270 of FIGS. 2A and 2B, or of other ripple counter circuits configured in accordance with various embodiments of the present technology.

As shown, the ripple counter circuit is reconfigurable depending on its use for intensity mode or depth mode. More specifically, while operating in depth mode, a multiplexer cascades multiple sets of flip flops (32 in the illustrated embodiment) together to enable the ripple counter circuit 570 to count (using the signal start) an amount of histogramming windows (e.g., a number of laser pulses emitted by an associated light source) for a given exposure period/depth frame. When a row of the SRAM saturates during depth mode, an overflow flag is generated (e.g., by a coupled MCFA circuit) that is used to halt further histogramming window counting by the ripple counter circuit. Were saturation to occur during exposure, absolute signal strength can be deduced from the signal peak of the histogram in conjunction with the frozen histogramming window counter value using Equation (4) above.

While operating in intensity mode, the multiplexer uncouples the multiple sets of flip flops. As a result, the ripple counter circuit 570 can include four ripple counters that each include two 4-bit counter circuits and are each configured to operate in a pipelined manner. For example, each of four SPADs can be individually connected to two of eight 4-bit counter circuits using a ping-pong buffer structure. The two 4-bit counter circuits of each ripple counter can operate in parallel. For example, each ripple counter can operate in a first phase or in a second phase. In the first phase, a first of the 4-bit counter circuits of a ripple counter can be used to count a number of event pulses received from a coupled SPAD FE while a second of the 4-bit counter circuits of the ripple counter can be used to output an associated photon event count to a coupled MCFA circuit for writing to a coupled SRAM. Control signals input into the ping-pong buffer structure can be used to reverse this arrangement (e.g., after a period of time) and transition the ripple counter to the second phase in which the second of the 4-bit counter circuits is used to count a number of event pulses received from a coupled SPAD FE while the first of the 4-bit counter circuits is used to output another associated photon event count to the coupled MCFA for writing to the coupled SRAM. In some embodiments, in the event a corresponding row of the SRAM becomes saturated during a given exposure period, counting by the corresponding ripple counter can be disabled.

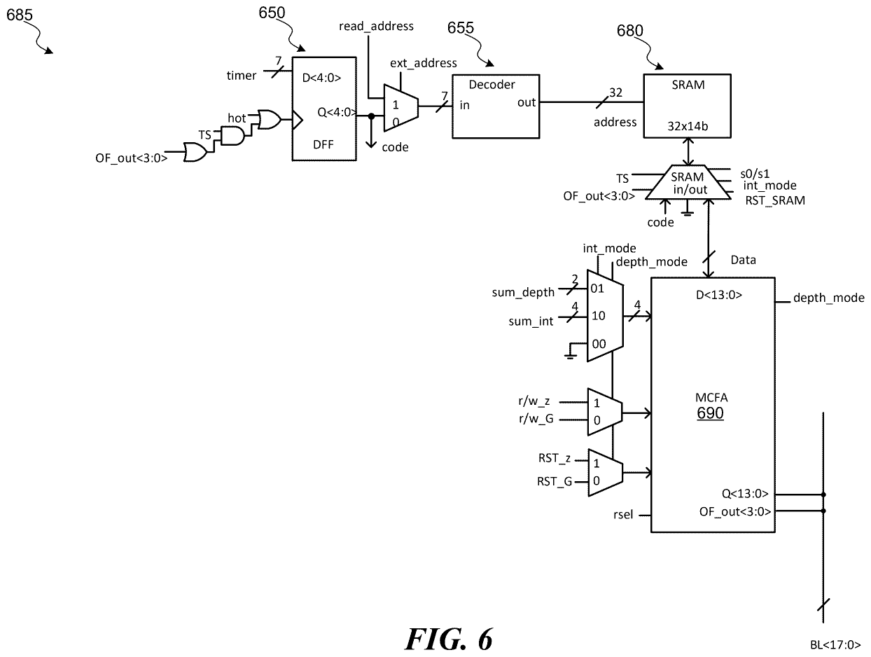

FIG. 6 is a partially schematic circuit diagram illustrating a timestamping, adding, and memory circuit 685 (“the circuit 685”) configured in accordance with various embodiments of the present technology. As shown, the circuit 685 includes a DFF circuit 650, an address multiplexer, a decoder 655, an SRAM 680, a bidirectional multiplexer, and an MCFA circuit 690. The DFF circuit 650, the address multiplexer, the decoder 655, the SRAM 680, the bidirectional multiplexer, and/or the MCFA circuit 690 can be examples of the DFF circuit 250, the address multiplexer, the decoder 255, the SRAM 280, the bidirectional multiplexer, and/or the MCFA circuit 290, respectively, of FIGS. 2A and 2B, or of other DFF circuits, address multiplexers, decoders, SRAMs, bidirectional multiplexers, and/or MCFA circuits, respectively, configured in accordance with various embodiments of the present technology.

Rows of the SRAM 680 can be directly selected (e.g., by row control circuit; not shown) via signals ext_address and read_address. Rows of the SRAM 680 that are directly selected via the signals ext_address and read_address can be reset by a RST_SRAM signal input into the bi-directional multiplexer.

As shown, the DFF circuit 650 is configured to receive timecode value from a coupled timer (e.g., the timer 240 of FIGS. 2A and 2B; not shown). While operating in depth mode, a timecode received at the DFF circuit 650 can be sampled when the signal hot is asserted. In turn, the sampled timecode can be fed into the decoder 655 via the address multiplexer and used to address a corresponding row of the SRAM 680 directly. As discussed above, in depth mode, each row of the SRAM 680 can corresponds to a bin of a histogram.

While operating in intensity mode, the SRAM 680 can be used to store intensity information (e.g., 14-bit intensity information) for each coupled SPAD. As discussed above, each coupled SPAD can be allocated at least one row for storing a corresponding photon event count and at least one row for storing associated timecode values code output from the DFF circuit 650 into the bi-directional multiplexer. During intensity mode, rows of the SRAM 680 are referenced using external read addresses read_address provided by row control circuitry (not shown) in order to generate the timing needed to toggle through the (e.g., four) coupled ripple counters (corresponding to the (e.g., four) corresponding SPADS).

The MCFA circuit 690 reads out data stored to the SRAM 680 via the bi-directional multiplexer when read/write pulse signals r/w_z (for depth mode) or r/w_G (for intensity mode) are asserted. Simultaneously, either a photon event count sum_int from a coupled rippled counter (for intensity mode) or a photon event count sum_depth from a summation circuit (for depth mode) are read into the MCFA circuit 690 and added (e.g., using a full adder, such as by updated photon event count=current photon event count+(sum_int or sum_depth)) to the data read out from the SRAM 680. At the falling edge of the corresponding read/write pulse r/w_z (for depth mode) or r/w_G (for intensity mode), the MCFA circuit 690 output can be latched and written back into the corresponding row of the SRAM 680. The latches can thereafter be reset using signal reset signal RST_z (for depth mode) or RST_G (for intensity mode).

In the event of saturation, the MCFA circuit 690 can output an overflow signal OF_out<3:0> that can correspond to every coupled SPAD of a group (for depth mode) or only a coupled SPAD whose allocated row in the SRAM 680 is saturated (for intensity mode). The overflow signal OF_out<3:0> and/or saturation signals s0/s1 can be input into the bi-directional multiplexer, into logic circuitry coupled to the DFF circuit 650, into a coupled summation circuit, into a coupled SPAD FE, and/or into a coupled ripple counter. In turn, for depth mode, generation of event pulses by the SPAD FE, accumulation of photon events in the coupled summation circuit, further counting of emitted light pulses by a coupled ripple counter, sampling of additional timecodes, and/or further reading out and updating of data stored to the SRAM 680 by the MCFA circuit 690 can be stopped. For intensity mode, generation of event pulses by the SPAD FE for a given SPAD, accumulation of photon events in a coupled ripple counter corresponding to the given SPAD, further sampling of timecodes for the SPAD, and/or further reading out and updating of data stored to the SRAM 680 by the MCFA circuit 690 and corresponding to the SPAD can be stopped. In addition, a timecode code corresponding to the time of saturation can be stored to a row of the SRAM 680 allocated to the given SPAD. The timecode code output from the DFF circuit 250 and input into the bi-directional multiplexer can be used to generate a timer saturate signal TS (indicating when a timer value provided by a timer coupled to the DFF circuit 650 has saturated) and/or the reset SRAM signal RST_SRAM.

During a read mode in which data stored to the SRAM 680 can be output onto a bitline BL via the MCFA circuit 690, an SRAM address is selected using signals read_address and ext_address. Using reset signals RST_G and r/w_G, latches at the MCFA circuit 690 can be reset while SRAM data is output onto the bitline BL while row select signal rsel is asserted. On the falling edge of read/write pulse r/w_G, the reset latch value can be written back into the SRAM 680 in place of the SRAM data output onto the bitline BL, thereby initializing the corresponding row of the SRAM for a next frame. If non-destructive read is desired, another signal can be added to prohibit overwriting.

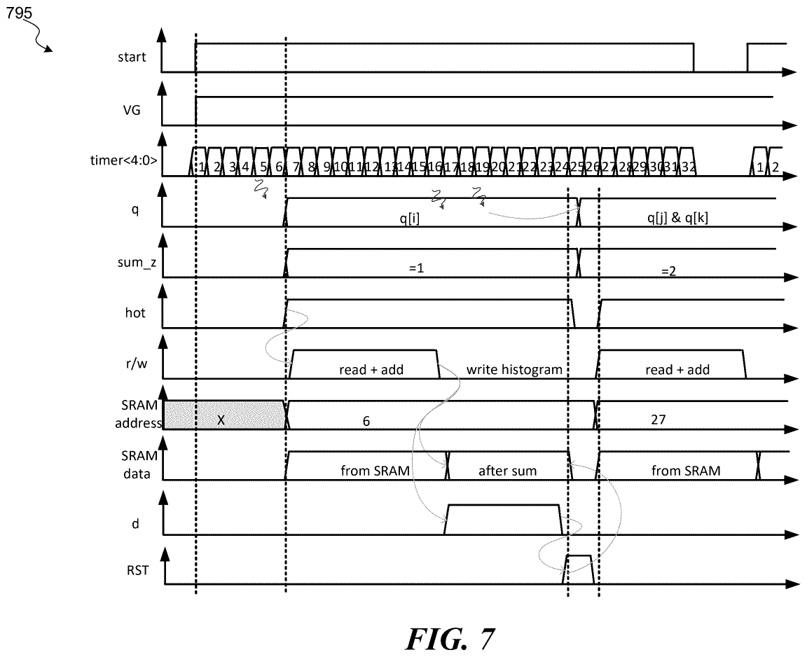

FIG. 7 is a timing diagram 795 illustrating a method of operating a reconfigurable SPAD sensor in a depth mode in accordance with various embodiments of the present technology. As shown by the diagram 795, SPADs can be initialized by asserting signal VG. A start pulse is generated upon the start of a histogramming window (corresponding to emission of a light pulse by an associated light source). The start pulse is used to increment the ripple counter to support intensity estimation in case of saturation. A firing SPAD results in an event pulse q output by the SPAD FE, upon which a signal hot is triggered and the sum of all realized events (simultaneous or formerly unresolved triggers) is computed at a summation circuit. The rising pulse of signal hot initiates sampling of a timecode in the DFF circuit. The sampled timecode is fed into the SRAM decoder and decoded into an address of a row in the SRAM. The SRAM is set to read, which cause the SRAM to read out a current photon event count stored to the row addressed by the timecode into the full adder, jointly with the sum_z (representing the sum of all realized events computed at the summation circuit). Upon the falling edge of the read/write pulse r/w_z, DFFs at the output of the full adder sample the updated photon event count value and write it back into the corresponding row of the SRAM. The write duration is defined by a pulse d. Upon the falling edge of the pulse d, a reset pulse RST is generated, thereby enabling SPADs to detect new photon events for timestamping (e.g., in accordance with the timestamp values timer<4:0> output by the timer). For depth mode, the SRAM read and write operations define the bottleneck for pile-up.

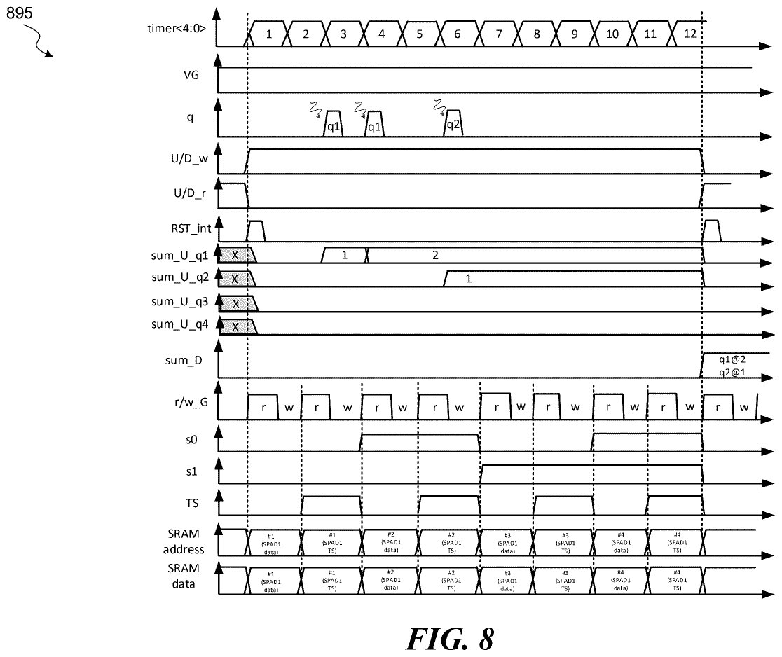

FIG. 8 is a timing diagram 895 illustrating a method of operating a reconfigurable SPAD sensor in an intensity mode in accordance with various embodiments of the present technology. As shown by the diagram 895, SPADs can be initialized by asserting signal VG. A signal U/D_w connects each SPAD to a dedicated 4-b counter circuit of a dedicated ripple counter to reduce the likelihood of photon pileup. In parallel, a photon event count maintained by another 4-bit counter circuit of the dedicated ripple counter is read, and summed with corresponding data read out from the SRAM before writing an updated value back into the SRAM. Read/write operations can be executed to process one side of the ping-pong ripple counter (e.g., 4 signal and 4 timestamps), and signals “s0” or “s1” are used to select one of the four ripple counters (each corresponding to one SPAD). After each photon event count is read out from a corresponding 4-bit counter circuit, a timecode from the timer is stored to a row of the SRAM associated with the SPAD corresponding to the photon event count. Each SPAD can therefore utilized two read/write cycles (e.g., one cycle to update and store the ripple counter value and one cycle to re-sample and store the timecode). Upon saturation neither the SRAM nor the ripple counter are updated. As a result, intensity can be determined indirectly through the frozen timestamp. The control signals for intensity mode are driven from row control circuitry.

### C. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A reconfigurable single-photon avalanche diode (SPAD) sensor, comprising:
a plurality of SPADs, each configured to detect a photon event corresponding to incident light from an external scene;
a summation circuit coupled to the plurality of SPADs and configured to, using a synchronous summation technique (SST), generate sums of photon events detected by the plurality of SPADs; and
an in-pixel static random-access memory (SRAM) coupled to the summation circuit and configured to store photon event counts that each correspond to at least one SPAD of the plurality of SPADs,
wherein the reconfigurable SPAD sensor is configurable to operate in (i) a depth mode in which the reconfigurable SPAD sensor is usable to obtain distance information related to an object within the external scene, and (ii) an intensity mode in which the reconfigurable SPAD sensor is usable to obtain intensity information corresponding to the incident light.

2. The reconfigurable SPAD sensor of claim 1, further comprising a ripple counter circuit coupled to the plurality of SPADs.

3. The reconfigurable SPAD sensor of claim 2, wherein the ripple counter circuit is configured to:
when the reconfigurable SPAD sensor operates in the depth mode, track a number of light pulses emitted, during an exposure period, by a light source associated with the reconfigurable SPAD sensor; and
when the reconfigurable SPAD sensor operates in the intensity mode, generate counter values for each SPAD of the plurality of SPAD, each counter value representing a number of photon events detected by a corresponding SPAD.

4. The reconfigurable SPAD sensor of claim 2, wherein the ripple counter circuit comprises:
a plurality of flip-flops arranged in two or more sets of flip-flops; and
a multiplexer configured to:
when the reconfigurable SPAD sensor operates in the depth mode, cascade two of the two or more sets to one another, and
when the reconfigurable SPAD sensor operates in the intensity mode, uncouple the two of the two or more sets from one another such that (a) each forms a respective counter circuit and (b) the respective counter circuits are arranged in parallel with one another.

5. The reconfigurable SPAD sensor of claim 4, wherein:
the ripple counter circuit includes a plurality of ripple counters, each ripple counter corresponding to one SPAD of the plurality of SPADs;
each ripple counter of the plurality of ripple counters comprises:
a first counter circuit, and
a second counter circuit; and
the first and second counter circuits are configured to operate in parallel using a ping-pong buffer structure.

6. The reconfigurable SPAD sensor of claim 2, further comprising:
a memory controller/full adder (MCFA) circuit coupled to the in-pixel SRAM, the summation circuit, and the ripple counter circuit,
wherein the MCFA circuit is configured to:
when the reconfigurable SPAD sensor operates in the depth mode, update first photon event counts stored to the in-pixel SRAM using the sums output by the summation circuit, and
when the reconfigurable SPAD sensor operates in the intensity mode, update second photon event counts stored to the in-pixel SRAM using counter values output by the ripple counter circuit, each counter value representing a number of photon events detected by a corresponding SPAD.

7. The reconfigurable SPAD sensor of claim 2, wherein:
when reconfigurable SPAD sensor operates in the depth mode, the summation circuit is enabled and configured to generate the sums of the photon events detected by the plurality of SPADs, and
when the reconfigurable SPAD sensor operates in the intensity mode, the summation circuit is disabled and the ripple counter circuit is configured to count photon events detected by each SPAD of the plurality of SPADs individually.

8. The reconfigurable SPAD sensor of claim 2, wherein:
the reconfigurable SPAD sensor further comprises a SPAD front-end (FE) coupled (a) between the plurality of SPADs and the summation circuit, and (b) between the plurality of SPADs and the ripple counter circuit;
the SPAD FE is configured to generate an event pulse based at least in part on one of the SPADs of the plurality of SPADs detecting a photon event;
when the reconfigurable SPAD sensor operates in the depth mode, the summation circuit is configured to receive and process event pulses output by the SPAD FE; and
when the reconfigurable SPAD sensor operates in the intensity mode, the ripple counter circuit is configured to receive and process event pulses output by the SPAD FE.

9. The reconfigurable SPAD sensor of claim 1, further comprising:
a timer configured to generate timecode values; and
a D flip-flop (DFF) circuit coupled to the timer and the summation circuit,
wherein, when the reconfigurable SPAD sensor operates in the depth mode, the DFF circuit is configured to sample a timecode output by the timer in response to the summation circuit detecting a photon event.

10. The reconfigurable SPAD sensor of claim 9, further comprising:
an address decoder; and
an address multiplexer coupled between the DFF circuit and the address decoder,
wherein the address multiplexer is configured to (a) pass a sampled timecode output from the DFF circuit to the address decoder when the reconfigurable SPAD sensor operates in the depth mode, and (b) pass an externally supplied address to address decoder when the reconfigurable SPAD sensor operates in the intensity mode.

11. The reconfigurable SPAD sensor of claim 1, wherein:
when the reconfigurable SPAD sensor operates in the depth mode, the in-pixel SRAM is configured to store a histogram of pulse counts across a plurality of rows, with each row of the plurality of rows corresponding to a bin of the histogram, and
when the reconfigurable SPAD sensor operates in the intensity mode, the in-pixel SRAM is configured to allocate at least two rows to each SPAD of the plurality of SPADs, the at least two rows including (a) a first row allocated to store a photon event count for a respective one of the plurality of SPADs and (b) a second row allocated to store an overflow timer value for the respective one of the plurality of SPADs.

12. A ripple counter circuit, comprising:
a ping-pong buffer; and
a plurality of flip flops coupled to the ping-pong buffer,
wherein the plurality of flip flops are reconfigurable based at least in part on an operation mode of the ripple counter circuit.

13. The ripple counter circuit of claim 12, wherein:
the operation mode is a first mode or a second mode;
the plurality of flip flops include multiple sets of flip flops;
the ripple counter circuit further comprises a multiplexer coupled to the multiple sets of flip flops; and
the multiplexer is configured to:
when the ripple counter circuit operates in the first mode, cascade two of the multiple sets to one another to increase a maximum count value that can be stored by the ripple counter circuit, and
when the ripple counter circuit operates in the second mode, uncouple the two of the multiple sets from one another such that each of the two of the multiple sets forms a respective counter circuit.

14. The ripple counter circuit of claim 13, wherein, when the ripple counter circuit operates in the second mode, the two respective counter circuits are configured to operate in parallel with one another.

15. The ripple counter circuit of claim 13, wherein:
when the ripple counter circuit operates in the second mode, the ripple counter circuit is configured to alternate operating in a first phase and a second phase;
in the first phase, a first of the two respective counter circuits is useable to count detected photon events while a second of the two respective counter circuits is usable to output a corresponding counter value; and
in the second phase, the second of the two respective counter circuits is usable to count additional detected photon events while the first of the two respective counter circuits is usable to output another corresponding counter value.

16. A method of operating a reconfigurable single-photon avalanche diode (SPAD) sensor in a depth mode in which the reconfigurable SPAD sensor is usable to obtain information indicating a distance to an object in an external scene, the method comprising:
summing, using a synchronous summation technique (SST) and during an exposure period, photon events detected by a group of two or more SPADs of the reconfigurable SPAD sensor, to generate a corresponding sum of the photon events; and
constructing a histogram of photon event counts corresponding to the exposure period, wherein constructing the histogram includes storing the corresponding sum to a row of an in-pixel static random-access memory (SRAM) as at least part of a photon event count stored to the row.

17. The method of claim 16, further comprising:
in response to detecting a photon event, sampling a timecode output by a timer; and
using the sampled timecode to access the row of the SRAM.

18. The method of claim 17, further comprising resetting the timer each time a new light pulse is emitted during the exposure period by a light source corresponding to the reconfigurable SPAD sensor.

19. The method of claim 16, further comprising:
in response to detecting a photon event, generating an asynchronous read/write pulse; and
using the asynchronous read/write pulse to control reading from and/or writing to the row of the SRAM.

20. The method of claim 16, further comprising tracking a number of emitted light pulses for the exposure period.

21. The method of claim 16, further comprising resetting all or a subset of the SPADs of the group after storing the corresponding sum to the row of the SRAM.

22. The method of claim 16, further comprising, in response to detecting, during the exposure period, saturation of one row of the SRAM corresponding to the histogram:
halting further accumulation of photon events in all rows of the SRAM; and
freezing a count of light pulses emitted during the exposure period, the count maintained by the reconfigurable SPAD sensor.

23. The method of claim 16, further comprising reconfiguring the reconfigurable SPAD sensor to operate in an intensity mode, wherein a same in-pixel SRAM, a same ripple counter, and a same SPAD front-end (FE) are used by the reconfigurable SPAD sensor in the intensity mode as are used by the reconfigurable SPAD sensor in the depth mode.

24. A method of operating a reconfigurable single-photon avalanche diode (SPAD) sensor in an intensity mode in which the reconfigurable SPAD sensor is usable to obtain intensity information corresponding to light from an external scene incident on one or more SPADs of the reconfigurable SPAD sensor during an exposure period, the method comprising:
counting, using a ripple counter circuit of the reconfigurable SPAD sensor, photon events detected by a SPAD of the one or more SPADs to generate a counter value; and
storing the counter value, as at least part of a photon event count for the SPAD, to an in-pixel static random-access memory (SRAM) of the reconfigurable SPAD sensor.

25. The method of claim 24, further comprising:
allocating at least two rows in the SRAM to the SPAD;
storing a photon event count for the SPAD to a first row of the at least two rows; and
storing timecodes to a second row of the at least two rows.

26. The method of claim 25, further comprising, in response to detecting saturation of the first row during the exposure period:
halting further accumulation of photon events in the first row; and
preventing further updating of a timecode stored in the second row.

27. The method of claim 24, further comprising using an address provided by external row control circuitry to access an appropriate row in the SRAM for storing the counter value as at least part of the photon event count for the SPAD.

28. The method of claim 24, wherein:
the ripple counter circuit comprises a first counter circuit and a second counter circuit dedicated to the SPAD at least while the reconfigurable SPAD sensor operates in the intensity mode;
the counter value is a first counter value maintained by the first counter circuit; and
the method further comprises updating the photon event count using the first counter value read out from the first counter circuit while using the second counter circuit to count additional photon events detected by the SPAD.

29. The method of claim 24, further comprising performing an active reset of the SPAD before a photon event detected by the SPAD is stored to the SRAM.

30. The method of claim 24, further comprising reconfiguring the reconfigurable SPAD sensor to operate in a depth mode, wherein a same in-pixel SRAM, a same ripple counter, and a same SPAD front-end (FE) are used by the reconfigurable SPAD sensor in the depth mode as are used by the reconfigurable SPAD sensor in the intensity mode.
